(19) United States
(12) Patent Application Publication
(10) Pub. No.: US 2014/0040462 A1
(43) Pub. Date: Feb. 6, 2014

(54) DEVICE MANAGEMENT SYSTEM, DEVICE MANAGEMENT APPARATUS, AND DEVICE MANAGEMENT METHOD

(71) Applicant: Shinsuke Harada, Tokyo (JP)

(72) Inventor: Shinsuke Harada, Tokyo (JP)

(73) Assignee: RICOH COMPANY, LIMITED, Tokyo (JP)

(21) Appl. No.: 13/957,591

(22) Filed: Aug. 2, 2013

(30) Foreign Application Priority Data
Aug. 6, 2012 (JP) 2012-174387

(51) Int. Cl. H04L 12/26

(52) U.S. Cl. CPC H04L 43/04
USPC 709/224

(57) ABSTRACT

A device management system manages an electronic device and a lighting device via a network and includes an acquiring section configured to acquire, from the first device, first operating history information relating to an operating history of the first device and acquire, from a monitor connected to the second device, second operating history information relating to an operating history of the second device, the second operating history information being of a type different from that of the first operating history information; a first generating section configured to generate first management information based on the first operating history information; and a second generating section configured to generate second management information of a type identical to that of the first management information based on the second operating history information.

### CROSS-REFERENCE TO RELATED APPLICATIONS

The present application claims priority to and incorporates by reference the entire contents of Japanese Patent Application No. 2012-174387 filed in Japan on Aug. 6, 2012.

### BACKGROUND OF THE INVENTION

1. Field of the Invention

The present invention relates to a device management system, a device management apparatus, and a device management method.

2. Description of the Related Art

Known device management apparatuses manage devices connected over a network by acquiring data from the devices (see, for example, Japanese Patent Application Laid-open No. 2004-030245).

### SUMMARY OF THE INVENTION

Types of devices that can be connected to a network vary widely in recent years and different types of data can be acquired from different types of devices. It is as such difficult at times to manage generally all devices to be managed.

The present invention has been made in view of the foregoing situation and it is an object of the present invention to provide a device management system, a device management apparatus, and a device management method that can generally manage different types of devices connected over a network.

### SUMMARY OF THE INVENTION

It is an object of the present invention to at least partially solve the problems in the conventional technology.

According to the present invention, there is provided: a device management system that manages a first device and a second device via a network. The device management system comprises: an acquiring section configured to acquire, from the first device, first operating history information relating to an operating history of the first device and acquire, from a monitor connected to the second device, second operating history information relating to an operating history of the second device, the second operating history information being of a type different from that of the first operating history information; a first generating section configured to generate first management information based on the first operating history information; and a second generating section configured to generate second management information of a type identical to that of the first management information based on the second operating history information.

The present invention also provides a device management apparatus that manages a first device and a second device via a network. The device management apparatus comprises: an acquiring section configured to acquire, from the first device, first operating history information relating to an operating history of the first device and acquire, from a monitor connected to the second device, second operating history information relating to an operating history of the second device, the second operating history information being of a type different from that of the first operating history information; a first generating section configured to generate first management information based on the first operating history information; and a second generating section configured to generate second management information of a type identical to that of the first management information based on the second operating history information.

The present invention also provides a device management method that manages a first device and a second device via a network. The device management method comprises: acquiring, from the first device, first operating history information relating to an operating history of the first device, and from a monitor connected to the second device, second operating history information relating to an operating history of the second device, the second operating history information being of a type different from that of the first operating history information; generating first management information based on the first operating history information; and generating second management information of a type identical to that of the first management information based on the second operating history information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an exemplary configuration of a device management system according to an embodiment of the present invention;

FIG. 2 is a block diagram illustrating an exemplary configuration of a monitor according to the embodiment of the present invention;

FIG. 3A is a configuration diagram illustrating an exemplary lighting device according to the embodiment of the present invention;

FIG. 3B is a configuration diagram illustrating an exemplary lighting device according to the embodiment of the present invention;

FIG. 4 is a block diagram illustrating an exemplary configuration of a collection server according to the embodiment of the present invention;

FIG. 5 is a block diagram illustrating an exemplary configuration of a report preparation server according to the embodiment of the present invention;

FIG. 6 is a diagram illustrating an exemplary property screen of an electronic device;

FIG. 7 is a diagram illustrating an exemplary property screen of a lighting device;

FIG. 8 is a diagram illustrating an exemplary property screen for all devices;

FIG. 9 is a diagram illustrating an exemplary total screen for all devices;

FIG. 10 is a sequence diagram illustrating an exemplary report preparation process performed by the device management system according to the embodiment of the present invention;

FIG. 11 is a block diagram illustrating an exemplary configuration of a device management system according to a tenth modification of the present invention; and

FIG. 12 is a block diagram illustrating an exemplary hardware configuration of an electronic device, a collection server, and a report preparation server according to the embodiment and each of modifications of the present invention.

### DETAILED DESCRIPTION OF THE PREFERRED EMBODIMENTS

A device management system, a device management apparatus, and a device management method according to an embodiment of the present invention will be described in detail below with reference to the accompanying drawings.

The following describes the device management system according to the embodiment of the present invention.

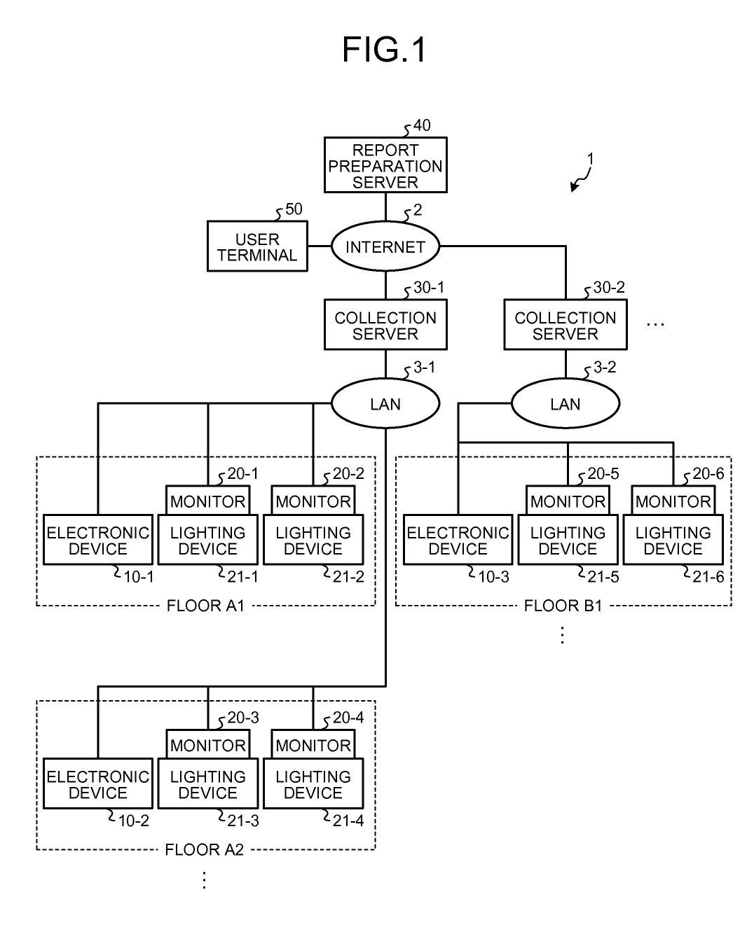

FIG. 1 is a block diagram illustrating an exemplary configuration of this device management system 1 according to the embodiment. As illustrated in FIG. 1, the device management system 1 includes electronic devices 10-1 to 10-3, monitors 20-1 to 20-6, lighting devices 21-1 to 21-6, collection servers 30-1, 30-2, a report preparation server 40, and a user terminal 50.

The collection servers 30-1, 30-2, the report preparation server 40, and the user terminal 50 are connected to each other via an internet 2. The electronic devices 10-1, 10-2, the monitors 20-1 to 20-4, and the collection server 30-1 are connected to each other via a local area network (LAN) 3-1. The electronic device 10-3, the monitors 20-5, 20-6, and the collection server 30-2 are connected to each other via a LAN 3-2. The Internet and the LANs exemplarily illustrated in this embodiment as networks for connecting different devices are not the only possible types of network.

In the embodiment, the electronic devices 10-1 to 10-3, the monitors 20-1 to 20-6, the lighting devices 21-1 to 21-6, the collection servers 30-1, 30-2, and the user terminal 50 are provided at a service base, while the report preparation server 40 is provided at a service center of a service provider that provides a device management service. The service base is an area in which the devices to be managed are installed. An office of a company (client) that receives the device management service, for example, is a service base. The service base is, however, not the only possible site at which the devices are installed.

The embodiment will describe an example in which the electronic device 10-1, the monitors 20-1, 20-2, and the lighting devices 21-1, 21-2 are installed on a floor A1 of the service base; the electronic device 10-2, the monitors 20-3, 20-4, and the lighting devices 21-3, 21-4 are installed on a floor A2 of the service base; and the electronic device 10-3, the monitors 20-5, 20-6, and the lighting devices 21-5, 21-6 are installed on a floor B1 of the service base. This exemplary case is, however, not the only possible arrangement.

The electronic devices 10-1 to 10-3 (exemplary first devices) may be any type of device that can be connected to a network, such as the internet 2 and the LAN 3-1, 3-2. The electronic devices 10-1 to 10-3 may, for example, be information processing apparatuses such as personal computers (PCs) and tablet terminals, image forming apparatuses such as printers, copying machines, multifunction peripherals (MFPs), scanners, and facsimile machines, and various other types of electronic devices such as projectors, cameras, air conditioners, refrigerators, fluorescent lights, vending machines, and handheld terminals. The MFF has at least two functions out of a copying function, a printing function, a scanner function, and a facsimile function. This embodiment will describe an example in which the electronic devices 10-1 to 10-3 are the MFPs. The exemplary case is, however, not the only possible arrangement.

The monitors 20-1 to 20-6 connect devices that cannot be connected to a network, such as the internet 2 and the LANs 3-1, 3-2, to the network therethrough. In this embodiment, the monitors 20-1 to 20-6 are connected to the lighting devices 21-1 to 21-6 to be monitored, respectively, and connect the lighting devices 21-1 to 21-6 to the LANs 3-1, 3-2 therethrough.

The lighting devices 21-1 to 21-6 (exemplary second devices) may be any type of lighting device, such as, for example, fluorescent lights, electric bulbs, and light emitting diode (LED) lights. This embodiment will describe an example in which the lighting devices 21-1 to 21-6 are the fluorescent lights. The exemplary case is, however, not the only possible arrangement.

The collection servers 30-1, 30-2 and the report preparation server 40 are device management apparatuses that manage, for example, the electronic devices 10-1 to 10-3 and the lighting devices 21-1 to 21-6. The electronic devices 10-1 to 10-3 and the lighting devices 21-1 to 21-6 exemplified in FIG. 1 are not the only possible devices to be managed by the collection servers 30-1, 30-2 and the report preparation server 40.

The collection server 30-1 collects information on the electronic devices 10-1, 10-2 and the lighting devices 21-1 to 21-4 via the LAN 3-1 and processes the collected information. The collection server 30-1 then sends the collected information or the processed information to the report preparation server 40 via the internet 2. The collection server 30-2 collects information on the electronic device 10-3 and the lighting devices 21-5, 21-6 via the LAN 3-2 and processes the collected information. The collection server 30-2 then sends the collected information or the processed information to the report preparation server 40 via the internet 2.

The report preparation server 40 manages the information sent by the collection servers 30-1, 30-2 via the internet 2 and, for example, prepares a report using the sent information.

Specifically, in the device management system 1 according to the embodiment of the present invention, the report preparation server 40 and the collection servers 30-1, 30-2 form a cascade structure to manage the devices to be managed.

The user terminal 50 is a terminal of a client. The user terminal 50 requests the report preparation server 40 on a browser displayed on a display not illustrated to, for example, prepare a report. The user terminal 50 acquires the report prepared by the report preparation server 40 and displays the acquired report on the browser.

In the descriptions that follow, the LANs 3-1, 3-2 may be referred to simply as a LAN 3, if there is no need to distinguish the LAN 3-1 from the LAN 3-2. Similarly, the electronic devices 10-1 to 10-3 may be referred to simply as an electronic device 10, if there is no need to make a distinction among the electronic devices 10-1 to 10-3; the monitors 20-1 to 20-6 may be referred to simply as a monitor 20, if there is no need to make a distinction among the monitors 20-1 to 20-6; the lighting devices 21-1 to 21-6 may be referred to simply as a lighting device 21, if there is no need to make a distinction among the lighting devices 21-1 to 21-6; and the collection servers 30-1, 30-2 may be referred to simply as a collection server 30, if there is no need to distinguish the collection server 30-1 from the collection server 30-2.

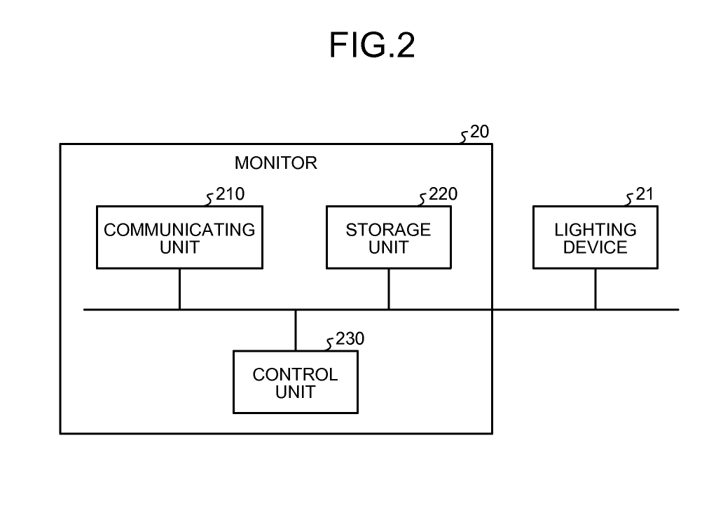

FIG. 2 is a block diagram illustrating an exemplary configuration of the monitor 20 according to the embodiment. As illustrated in FIG. 2, the monitor 20 includes a communicating unit 210, a storage unit 220, and a control unit 230. The monitor 20 is connected to the lighting device 21. The embodiment assumes that the monitor 20 is externally connected to the lighting device 21. This is, however, not the only possible arrangement and the monitor 20 may still be included in, and internally connected to, the lighting device 21.

The communicating unit 210 communicates with an external device, such as the collection server 30. The communicating unit 210 can be achieved by, for example, a network interface card (NIC).

The storage unit 220 stores therein, for example, various programs executed by the monitor 20 and data used for various processes performed by the monitor 20. For example, the storage unit 220 stores therein a rated electricity amount and a total lighting time of the lighting device 21 connected thereto. The storage unit 220 may also store therein a state of the lighting device 21 (whether the lighting device 21 is steadily lit) or an operation start date and time at which the lighting device 21 starts operating. The storage unit 220 can be achieved by at least any one of, for example, magnetically, optically, or electrically recordable storage devices, such as a hard disk drive (HDD), a solid state drive (SSD), a memory card, an optical disk, a read only memory (ROM), and a random access memory (RAM).

The control unit 230 controls different elements of the monitor 20. The control unit 230 can be achieved by a control device such as a central processing unit (CPU). The control unit 230 monitors steady lighting of the lighting device 21 connected to the monitor 20 and manages the total lighting time on the storage unit 220.

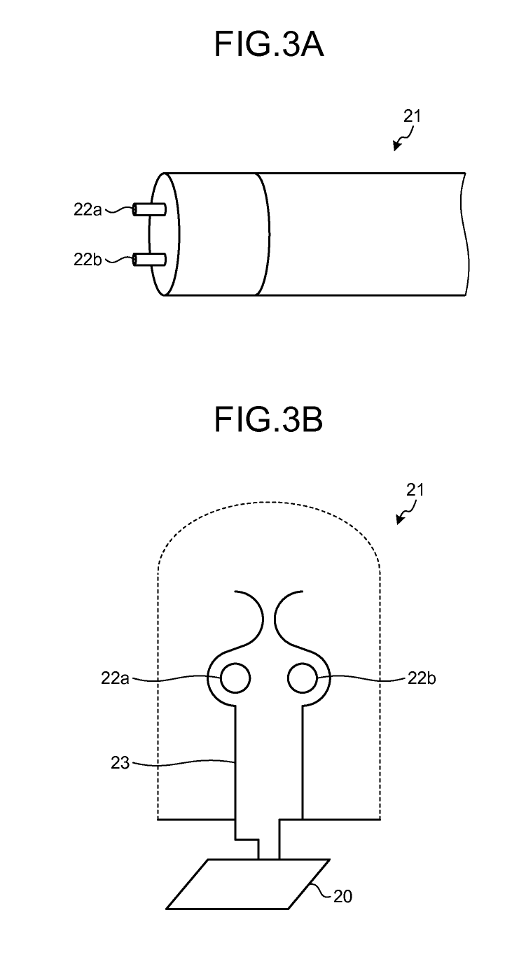

FIGS. 3A and 3B are configuration diagrams illustrating an exemplary lighting device 21 according to the embodiment of the present invention. As illustrated in FIGS. 3A and 3B, the lighting device (fluorescent light) 21 includes electrode sockets 22a, 22b and an electrode 23.

The electrode sockets 22a, 22b are grounded to the electrode 23. The control unit 230 of the monitor 20 connected to the lighting device 21 detects current that flows through the electrode 23 and monitors steady lighting of the lighting device 21 using a value of the detected current. If, for example, the detected current value is equal to or more than a threshold value, the control unit 230 of the monitor 20 determines that the connected lighting device 21 is steadily lit and starts counting lighting time. When the detected current value becomes less than the threshold value, the control unit 230 stops counting the lighting time and adds the lighting time count to the total lighting time stored in the storage unit 220.

In FIGS. 3A and 3B, the sockets of the fluorescent light were used to exemplify a monitoring technique of the monitor 20. The similar technique can still be applied to other types of sockets.

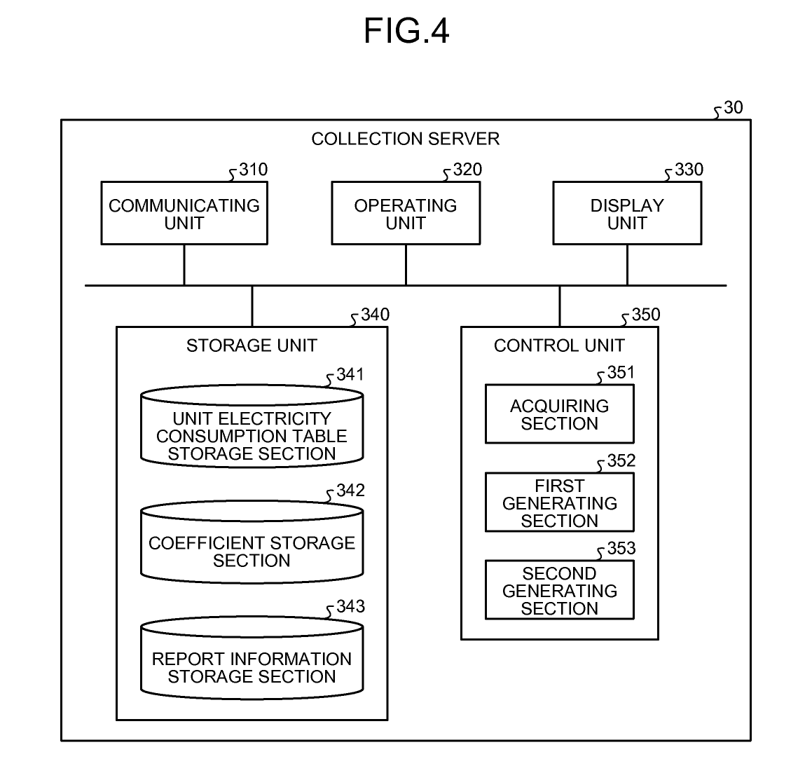

FIG. 4 is a block diagram illustrating an exemplary configuration of the collection server 30 according to the embodiment of the present invention. As illustrated in FIG. 4, the collection server 30 includes a communicating unit 310, an operating unit 320, a display unit 330, a storage unit 340, and a control unit 350.

The communicating unit 310 communicates with an external device, such as the report preparation server 40, the electronic device 10, or the monitor 20, via the internet 2 or the LAN 3. The communicating unit 310 can be achieved by, for example, a NIC.

The operating unit 320 allows various types of operations to be entered. The operating unit 320 can be achieved by an input device such as a keyboard, a mouse, a touch pad, and a touch panel.

The display unit 330 displays various types of screens. The display unit 330 can be achieved by a display device such as a liquid crystal display and a touch panel display.

The storage unit 340 stores therein, for example, a device management program for collecting information and other types of programs executed by the collection server 30 and data used for various processes performed by the collection server 30. The storage unit 340 can be achieved by at least any one of, for example, magnetically, optically, or electrically recordable storage devices such as an HDD, an SSD, a memory card, an optical disk, a ROM, and a RAM. The storage unit 340 includes a unit electricity consumption table storage section 341, a coefficient storage section 342, and a report information storage section 343. The report information storage section 343 will be described later.

The unit electricity consumption table storage section 341 stores therein a unit electricity consumption table that specifies model information indicating a model associated with unit electricity consumption information indicating electricity consumption per unit time. The unit electricity consumption is calculated based on a typical electricity consumption (TEC) value. For example, weekly electricity consumption of the MFF is daily electricity consumption in an ordinary mode×5 days (for weekdays) daily electricity consumption in an off mode or sleep mode×2 days (for Saturday and Sunday).

The coefficient storage section 342 stores therein a carbon dioxide emission coefficient (hereinafter referred to as a “CO₂ emission coefficient”). The CO₂ emission coefficient is a coefficient for deriving an amount of carbon dioxide emissions (hereinafter referred to as a “CO₂ emission amount”) from the electricity consumption.

The control unit 350 controls different elements of the collection server 30. The control unit 350 can be achieved by a control device, such as a CPU. The control unit 350 includes an acquiring section 351, a first generating section 352, and a second generating section 353. It is noted that the control unit 350 starts (and executes) the device management program for collecting information stored in the storage unit 340 to achieve the acquiring section 351, the first generating section 352, and the second generating section 353 as software.

The acquiring section 351 acquires, from the electronic device 10, first operating history information relating to an operating history of the electronic device 10 and acquires, from the monitor 20 connected to the lighting device 21, second operating history information relating to an operating history of the lighting device 21 and of a type different from that of the first operating history information. Specifically, the acquiring section 351 acquires the first operating history information and the second operating history information based on a request for acquisition of report information made from the report preparation server 40. The acquiring section 351 acquires the first operating history information and the second operating history information using, for example, a general-purpose protocol generally used in device management, such as a simple network management protocol (SNMP).

In the embodiment, the first operating history information indicates a model and an operation start date and time. This is, however, not the only possible arrangement and the first operating history information may further indicate, for example, an IP address and an identifier that identifies a specific electronic device 10. By way of example and not limitation, the model is a model name and the identifier is a serial number. The model, the operation start date and time, and the identifier are stored in a storage section not illustrated of the electronic device 10. The second operating history information indicates the rated electricity amount and the total lighting time. This is, however, not the only possible arrangement and the second operating history information may further indicate, for example, an IP address, a state of the lighting device 21 (whether the lighting device 21 is steadily lit), and the operation start date and time.

The first generating section 352 generates first management information based on the first operating history information acquired by the acquiring section 351. The first generating section 352 then stores the first operating history information acquired by the acquiring section 351, the generated first management information, information used during the process of generating the first management information, and the like as report information in the report information storage section 343. Additionally, the first generating section 352 transmits the first operating history information acquired by the acquiring section 351, the generated first management information, information used during the process of generating the first management information, and the like to the report preparation server 40. In the embodiment, by way of example and not limitation, the first management information indicates the CO₂ emission amount.

Specifically, the first generating section 352 refers to the unit electricity consumption table stored in the unit electricity consumption table storage section 341 to thereby acquire the unit electricity consumption information associated with the model indicated by the first operating history information. The first generating section 352 then calculates the CO₂ emission amount using the electricity consumption per unit period indicated by the acquired unit electricity consumption information, the operation start date and time indicated by the first operating history information, and the CO₂ emission coefficient stored in the coefficient storage section 342.

For example, the first generating section 352 calculates the operating period from the current time of day and the operation start date and time and uses an expression (1) to calculate the CO₂ emission amount. It is noted that the current time of day may be calculated internally by the control unit 350 or a value acquired by the control unit 350 from, for example, a network time protocol (NTP) not illustrated may be used for the current time of day.

CO₂ emission amount=electricity consumption per unit period×operating period×CO₂ emission coefficient (1)

The second generating section 353 generates second management information of the same type as the first management information based on the second operating history information acquired by the acquiring section 351. The second generating section 353 then stores the second operating history information acquired by the acquiring section 351, the generated second management information, information used during the process of generating the second management information, and the like as report information in the report information storage section 343. Additionally, the second generating section 353 transmits the second operating history information acquired by the acquiring section 351, the generated second management information, information used during the process of generating the second management information, and the like to the report preparation server 40. In the embodiment, by way of example and not limitation, the second management information indicates the CO₂ emission amount, or may be any type of information of the same type as the first management information.

Specifically, the second generating section 353 calculates the CO₂ emission amount using the rated electricity amount and the total lighting time indicated by the second operating history information and the CO₂ emission coefficient stored in the coefficient storage section 342. For example, the second generating section 353 calculates the CO₂ emission amount using an expression (2).

CO₂ emission amount=rated electricity amount×the total lighting time×CO₂ emission coefficient (2)

It is noted that the collection server 30 does not necessarily require all of the elements described above and may have some parts of the elements omitted.

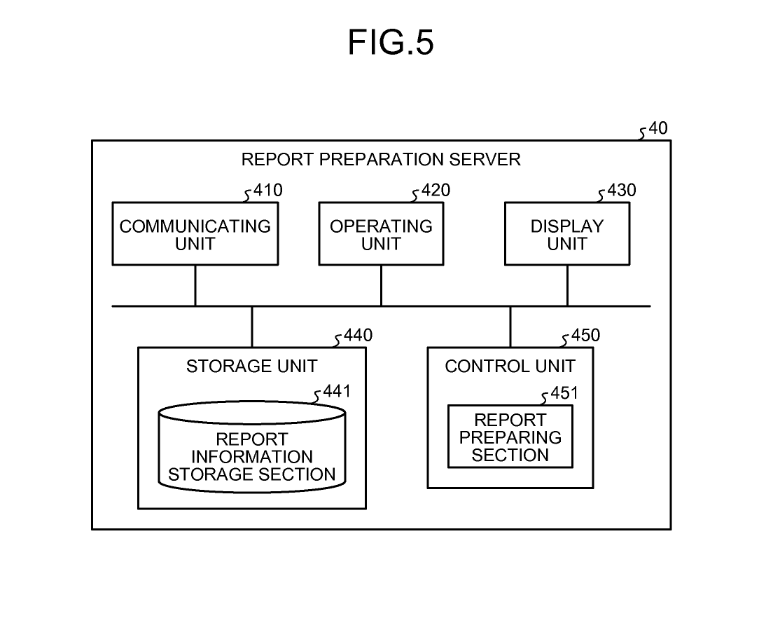

FIG. 5 is a block diagram illustrating an exemplary configuration of the report preparation server 40 according to the embodiment of the present invention. As illustrated in FIG. 5, the report preparation server 40 includes a communicating unit 410, an operating unit 420, a display unit 430, a storage unit 440, and a control unit 450.

The communicating unit 410 communicates with an external device, such as the collection server 30 and the user terminal 50, via the Internet 2. The communicating unit 410 can be achieved by a NIC.

The operating unit 420 allows various types of operations to be entered. The operating unit 420 can be achieved by an input device, such as a keyboard, a mouse, a touch pad, and a touch panel.

The display unit 430 displays various types of screens. The display unit 430 can be achieved by a display device such as a liquid crystal display and a touch panel display.

The storage unit 440 stores therein, for example, a device management program for preparing reports and other types of programs executed by the report preparation server 40 and data used for various processes performed by the report preparation server 40. The storage unit 440 can be achieved by at least any one of, for example, magnetically, optically, or electrically recordable storage devices, such as an HDD, an SSD, a memory card, an optical disk, a ROM, and a RAM. The storage unit 440 includes a report information storage section 441. The report information storage section 441 will be described later.

The control unit 450 controls different elements of the report preparation server 40. The control unit 450 can be achieved by a control device such as a CPU. The control unit 450 includes a report preparing section 451. It is noted that the control unit 450 starts (and executes) the device management program for preparing reports stored in the storage unit 440 to achieve the report preparing section 451 as software.

The report preparing section 451 prepares a report based on the first management information and the second management information generated by the collection server 30. Specifically, the report preparing section 451 makes a report information acquiring request to the collection server 30 to thereby acquire the report information based on an instruction issued via the user terminal 50 to acquire the report information. The report preparing section 451 then stores the report information in the report information storage section 441. Then, based on a report preparing instruction from the user terminal 50, the report preparing section 451 prepares an electronic report using the report information including the first management information and the second management information stored in the report information storage section 441 and outputs the electronic report to the user terminal 50 via the Internet 2. The report preparing section 451 may prepare, for example, a report that directly incorporates the report information or integrates the first management information and the second management information.

It is noted that the report preparation server 40 does not necessarily require all of the elements described above and may have some parts of the elements omitted.

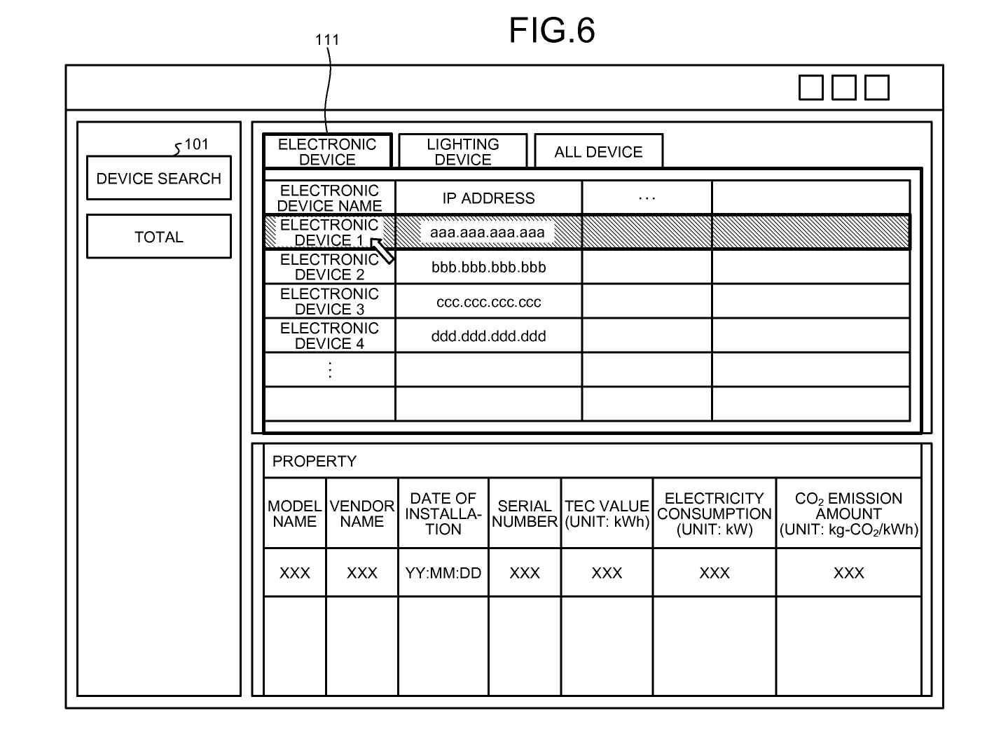

FIGS. 6 to 9 illustrate exemplary reports (report screens) according to the embodiment of the present invention, prepared by the report preparation server 40 and output by the user terminal 50.

FIG. 6 is a diagram illustrating an exemplary property screen of the electronic device 10. In the example illustrated in FIG. 6, the touch of a “device search” button 101 by the user causes devices installed in the service base to be searched through; the selection of an “electronic device” tab 111 causes a list of electronic devices out of the devices searched through to appear; and the selection of the electronic device 10 (“electronic device 1” in the example illustrated in FIG. 6) from the list causes a property screen for the electronic device 10 in question to appear. It is noted that the device search may also be performed by specifying a subnet.

In the example illustrated in FIG. 6, the property screen for the electronic device 10 displays the model name, vendor name, date of installation, serial number, TEC value, electricity consumption, and CO₂ emission amount of the electronic device 10 in question. The display items are not, however, limited to only those illustrated in FIG. 6.

The model name, the vendor name, the date of installation, and the serial number are examples of the first operating history information. The date of installation is synonymous with the operation start date and time. The CO₂ emission amount is an example of the first management information. The TEC value and the electricity consumption are examples of information generated during the process of generating the first management information. The electricity consumption is the electricity consumption per unit period multiplied by the operating period.

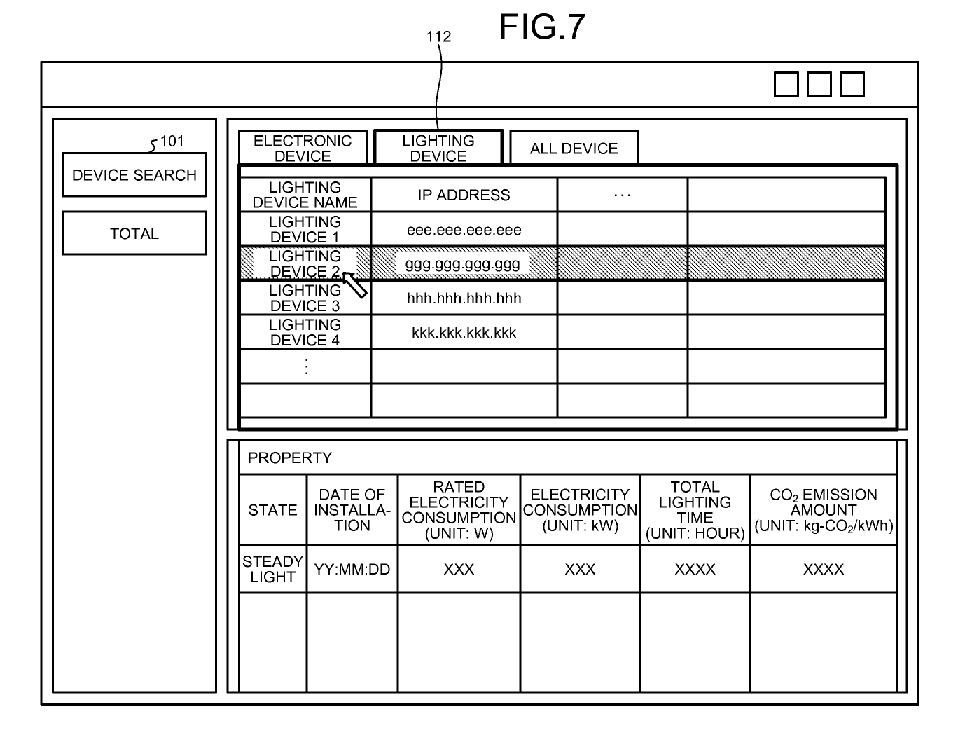

FIG. 7 is a diagram illustrating an exemplary property screen of the lighting device 21. In the example illustrated in FIG. 7, the touch of the “device search” button 101 by the user causes devices installed in the service base to be searched through; the selection of a “lighting device” tab 112 causes a list of lighting devices out of the devices searched through to appear; and the selection of the lighting device 21 (“lighting device 2” in the example illustrated in FIG. 7) from the list causes a property screen for the lighting device 21 to appear.

In the example illustrated in FIG. 7, the property screen for the lighting device 21 displays the state, date of installation, rated electricity amount, electricity consumption, total lighting time, and CO₂ emission amount of the lighting device 21. The display items are not, however, limited to only those illustrated in FIG. 7.

The state, the date of installation, the rated electricity amount, and the total lighting time are examples of the second operating history information. The CO₂ emission amount is an example of the second management information. The electricity consumption is an example of information generated during the process of generating the second management information. The electricity consumption is the rated electricity amount multiplied by the total lighting time.

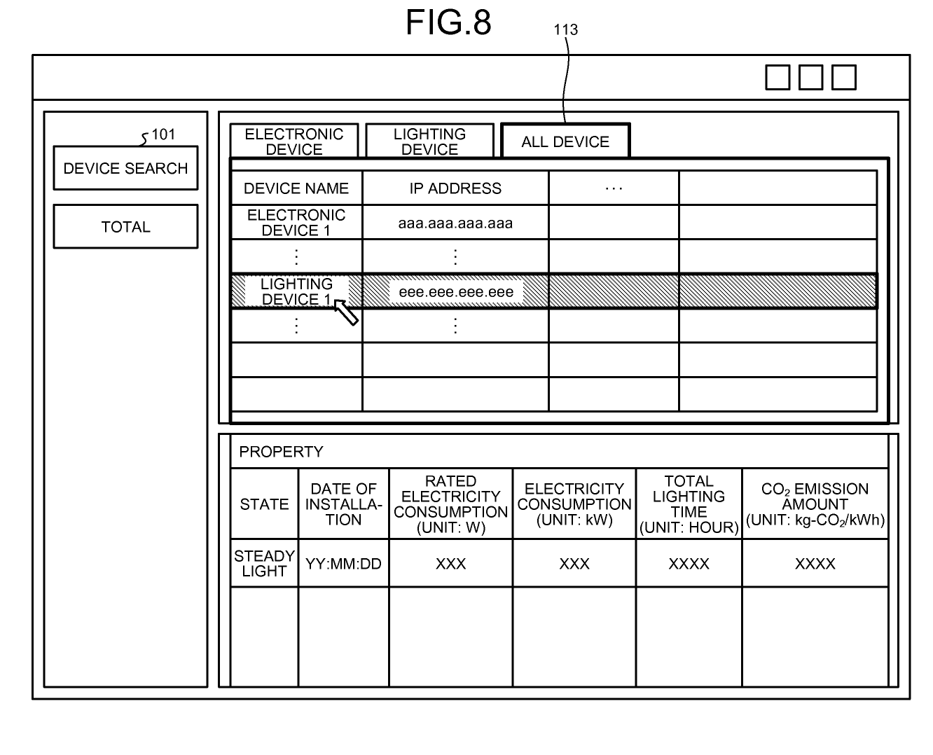

FIG. 8 is a diagram illustrating an exemplary property screen for all devices. In the example illustrated in FIG. 8, the touch of the “device search” button 101 by the user causes devices installed in the service base to be searched through; the selection of an “all device” tab 113 causes a list of devices (electronic devices and lighting devices) searched through to appear; and the selection of the device (“lighting device 1” in the example illustrated in FIG. 8) from the list causes a property screen for the device to appear.

The property screen for the electronic device 10 is similar to that illustrated in FIG. 6 and the property screen for the lighting device 21 is similar to that illustrated in FIG. 7 and thus descriptions therefor will be omitted.

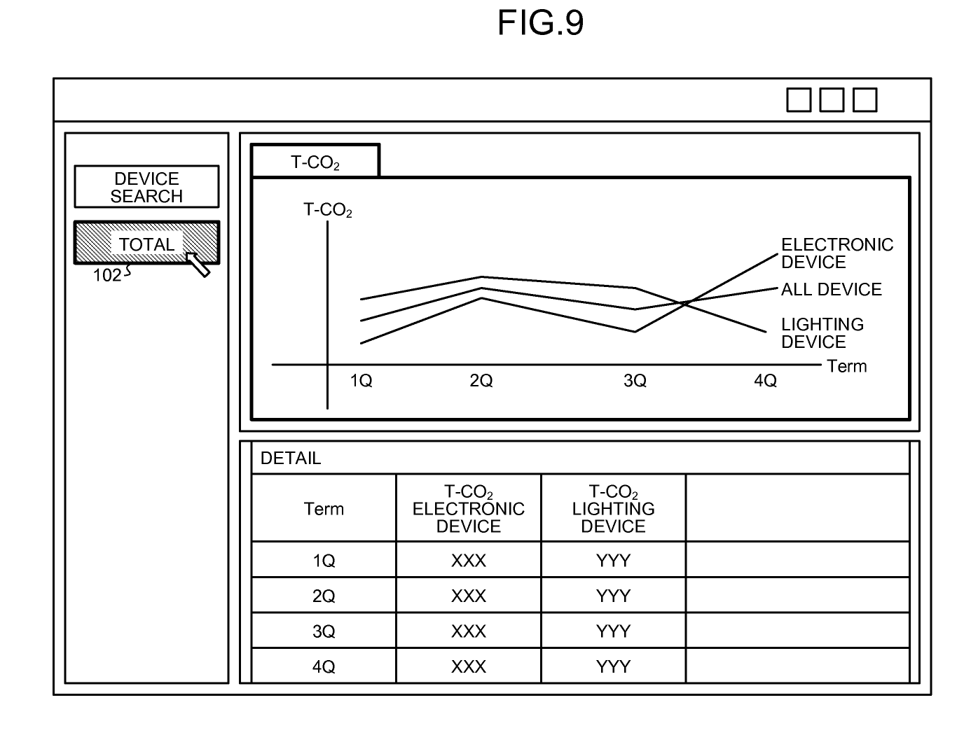

FIG. 9 is a diagram illustrating an exemplary total screen for all devices. In the example illustrated in FIG. 9, the touch of a “total” button 102 by the user causes devices installed in the service base to be searched through and a total CO₂ emission amount screen to appear, the total CO₂ emission amount screen displaying a total CO₂ emission amount for each group of the electronic devices, the lighting devices, and all devices. The example illustrated in FIG. 9 displays a total CO₂ emission amount for each term. This is, however, not the only possible arrangement and the total screen may display an aggregate total CO₂ emission amount for the period from the operation start to date. If the total screen displays the total CO₂ emission amount for each term as illustrated in FIG. 9, the collection server 30 only needs to calculate the CO₂ emission amount for each term.

Operation of the device management system according to the embodiment of the present invention will be described below.

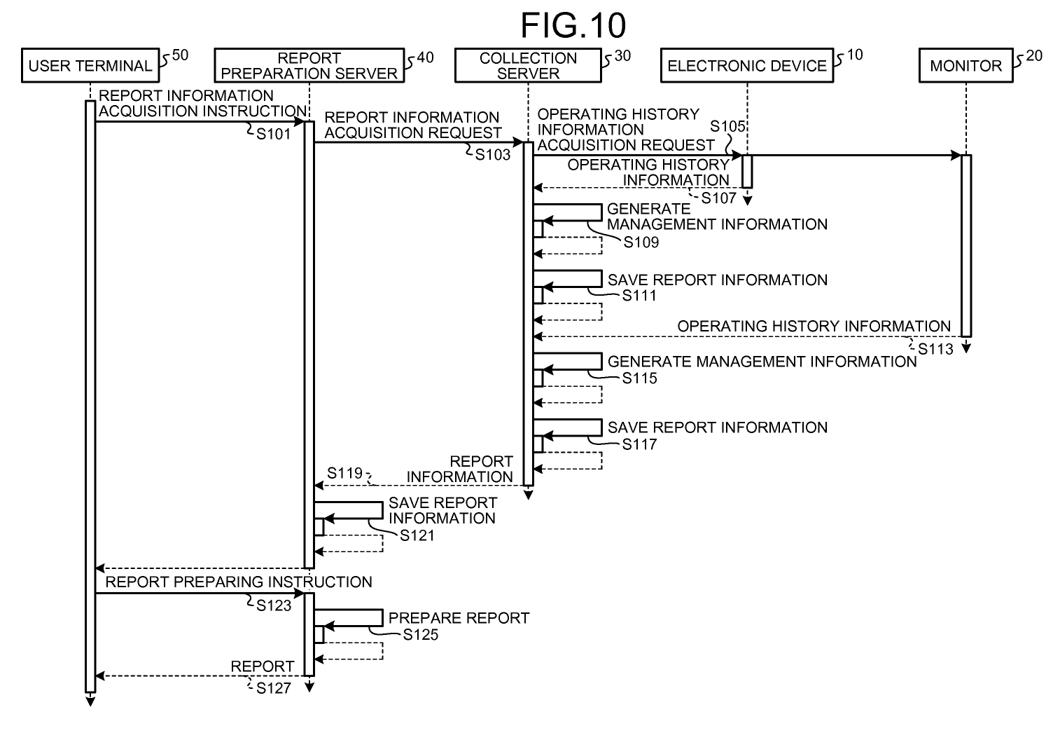

FIG. 10 is a sequence diagram illustrating an exemplary report preparation process performed by the device management system 1 according to the embodiment of the present invention.

The user terminal 50 first issues an instruction to the report preparation server 40 to acquire the report information (Step S101).

Next, the report preparing section 451 of the report preparation server 40 makes a report information acquiring request to the collection servers 30-1, 30-2 (Step S103).

Then, the acquiring section 351 of the collection server 30-1 requests the electronic devices 10-1, 10-2 for the first operating history information and the monitors 20-1 to 20-4 for the second operating history information. Similarly, the acquiring section 351 of the collection server 30-2 requests the electronic device 10-3 for the first operating history information and the monitors 20-5, 20-6 for the second operating history information (Step S105).

The acquiring section 351 of the collection server 30-1 acquires the first operating history information from each of the electronic devices 10-1, 10-2. The acquiring section 351 of the collection server 30-2 acquires the first operating history information from the electronic device 10-3 (Step S107).

The first generating section 352 of the collection server 30-1 then generates the first management information of each of the electronic devices 10-1, 10-2 based on the first operating history information acquired by the acquiring section 351. The first generating section 352 of the collection server 30-2 generates the first management information of the electronic device 10-3 based on the first operating history information acquired by the acquiring section 351 (Step S109).

The first generating section 352 of the collection server 30-1 then saves (stores), for each of the electronic devices 10-1, 10-2, the first operating history information, the first management information, the information used during the process of generating the first management information, and the like as the report information in the report information storage section 343 of the collection server 30-1. Similarly, the first generating section 352 of the collection server 30-2 saves (stores), for the electronic devices 10-3, the first operating history information, the first management information, the information used during the process of generating the first management information, and the like as the report information in the report information storage section 343 of the collection server 30-2 (Step S111).

The acquiring section 351 of the collection server 30-1 acquires the second operating history information from each of the monitors 20-1 to 20-4. The acquiring section 351 of the collection server 30-2 acquires the second operating history information from each of the monitors 20-5, 20-6 (Step S113).

The second generating section 353 of the collection server 30-1 then generates the second management information of each of the lighting devices 21-1 to 21-4 based on the second operating history information acquired by the acquiring section 351. The second generating section 353 of the collection server 30-2 generates the second management information of each of the lighting devices 21-5, 21-6 based on the second operating history information acquired by the acquiring section 351 (Step S115).

The second generating section 353 of the collection server 30-1 then saves (stores), for each of the lighting devices 21-1 to 21-4, the second operating history information, the second management information, the information used during the process of generating the second management information, and the like as the report information in the report information storage section 343 of the collection server 30-1. Similarly, the second generating section 353 of the collection server 30-2 saves (stores), for each of the lighting devices 21-5, 21-6, the second operating history information, the second management information, the information used during the process of generating the second management information, and the like as the report information in the report information storage section 343 of the collection server 30-2 (Step S117).

Then, the collection server 30-1 sends the report information saved in the report information storage section 343 of the collection server 30-1 to the report preparation server 40 and the collection server 30-2 sends the report information saved in the report information storage section 343 of the collection server 30-2 to the report preparation server 40 (Step S119). This allows the report information to be synchronized between the collection server 30 and the report preparation server 40, so that, for example, the report information saved in the collection server 30 can be used for backup purposes.

The report preparing section 451 of the report preparation server 40 receives the report information from the collection servers 30-1, 30-2 and saves (stores) the report information in the report information storage section 441 (Step S121).

The user terminal 50 issues a report preparing instruction to the report preparation server 40 (Step S123).

The report preparing section 451 of the report preparation server 40 prepares an electronic report using the report information including the first management information and the second management information stored in the report information storage section 441 (Step S125) and outputs the electronic report to the user terminal 50 (Step S127).

As described heretofore, in the embodiment of the present invention, while the first operating history information (the model and the operation start date and time) that can be acquired from the electronic device and the second operating history information (the rated electricity amount and the total lighting time) that can be acquired from the lighting device (the monitor) are the operating history information of types different from each other, the first management information generated based on the first operating history information and the second management information generated based on the second operating history information are the management information (CO₂ emission amount) of the same type. Thus, in the embodiment of the present invention, use of the first management information and the second management information for management enables various types of devices including the electronic devices and the lighting devices to be generally managed.

In the embodiment of the present invention, the first management information and the second management information are the management information of the same type. Thus, the preparation of a report based on the first management information and the second management information enables a report covering generally the entire devices to be prepared, should the management entail various types of devices including the electronic devices and the lighting devices.

Modifications

It should be noted that the present invention is not limited to the above-described embodiment and may include various modifications.

First Modification

In the above-described embodiment, the first generating section 352 generates the first management information during the operating period and the second generating section 353 generates the second management information during the operating period. An arrangement may nonetheless be made to cause the first generating section 352 to generate the first management information during a specified calculation period and the second generating section 353 to generate the second management information during a specified calculation period. In this case, the calculation period may be specified as part of the instruction issued from the user terminal 50 to the report preparation server 40 to acquire the report information (the request made from the report preparation server 40 to the collection server 30 to acquire the report information). In addition, the acquiring section 351 is to acquire the total lighting time for the calculation period specified by the monitor 20 as the second operating history information.

Second Modification

In the above-described embodiment, the acquiring section 351 acquires the first operating history information and the second operating history information from all devices to be managed. An arrangement may nonetheless be made, out of a plurality of first devices and a plurality of second devices, to cause the acquiring section 351 to acquire the first operating history information of a first device installed at a specified site and the second operating history information of a second device installed at the specified site. In this case, the specific site (e.g., the floor A1 or the floor A2) may be specified as part of the instruction issued from the user terminal 50 to the report preparation server 40 to acquire the report information (the request made from the report preparation server 40 to the collection server 30 to acquire the report information). The site may even be specified using, for example, the IF address.

Third Modification

The first management information and the second management information, while being the CO₂ emission amount according to the above-described embodiment, may still be the electricity consumption or both the CO₂ emission amount and the electricity consumption. The electricity consumption can be obtained during the process of calculating the CO₂ emission amount using the expressions (1) and (2). Specifically, the electricity consumption can be obtained by eliminating multiplication by the CO₂ emission coefficient in the expressions (1) and (2).

Fourth Modification

The first management information and the second management information, while being the CO₂ emission amount according to the above-described embodiment, may even be both the CO₂ emission amount and electricity charges, or the electricity charges. In this case, the coefficient storage section 342 further stores therein an electricity charge calculating coefficient. The electricity charges can be obtained by changing the multiplication by the CO₂ emission coefficient to multiplication by the electricity charge calculating coefficient in the expressions (1) and (2).

Fifth Modification

The second management information, while being the CO₂ emission amount according to the above-described embodiment, may further include use frequency. In this case, an arrangement may be made so that the second operating history information further indicates the operation start date and time and the second generating section 353 further calculates the use frequency using the total lighting time and the operation start date and time indicated by the second operating history information. For example, the second generating section 353 calculates the operating period from the current time of day and the operation start date and time and then calculates the use frequency using an expression (3).

Use frequency=total lighting time/operating period (3)

Sixth Modification

The second management information, while being the CO₂ emission amount according to the above-described embodiment, may further include presence of a fault. In this case, an arrangement may be made so that the second operating history information further indicates the last lighting end date and time and the second generating section 353 determines the presence of a fault based on the last lighting end date and time indicated by the second operating history information. For example, the second generating section 353 calculates the last non-lighting period from the current time of day and the last lighting end date and time. The second generating section 353 may then determine the presence of a fault, if the last non-lighting period exceeds a threshold value.

Seventh Modification

In the above-described embodiment, the report preparing section 451 prepares a report for each of the electronic devices, the lighting devices, and all devices. An arrangement may nonetheless be made to cause the report preparing section 451 to prepare a report for each model of the electronic devices and the lighting devices. In this case, the second operating history information further indicates the model and the report preparing section 451 prepares a report that integrates the first management information for each model and a report that integrates the second management information for each model. The report may include the number of models for which the management information has been integrated. The models of the lighting device may be stored in advance in the monitor 20 connected to the lighting device 21. Alternatively, the monitor 20 may acquire the models of the lighting device from the lighting device 21. The total CO₂ emission amount can thereby be notified for each model of the electronic device and the lighting device.

Eighth Modification

In the above-described embodiment, the collection server 30 may monitor to determine whether an IP address already used for the electronic device 10 or the monitor 20 (the lighting device 21) is used for another electronic device 10 or monitor 20 (lighting device 21). If the collection server 30 then finds a device that uses an IP address that has already been used, an arrangement may then be made so that the two devices are not to be managed as one device. For example, the collection server 30 identifies MAC addresses and manages two devices as two different devices, if the two devices have the same IP address, but different MAC addresses. This prevents two different devices from being managed as one.

Ninth Modification

In the above-described embodiment, an access control list (ACL) may be set for access by the collection server 30 to the electronic device 10 or the monitor 20. In this case, access information may be included in the instruction issued from the user terminal 50 to the report preparation server 40 to acquire the report information (the request made from the report preparation server 40 to the collection server 30 to acquire the report information).

Tenth Modification

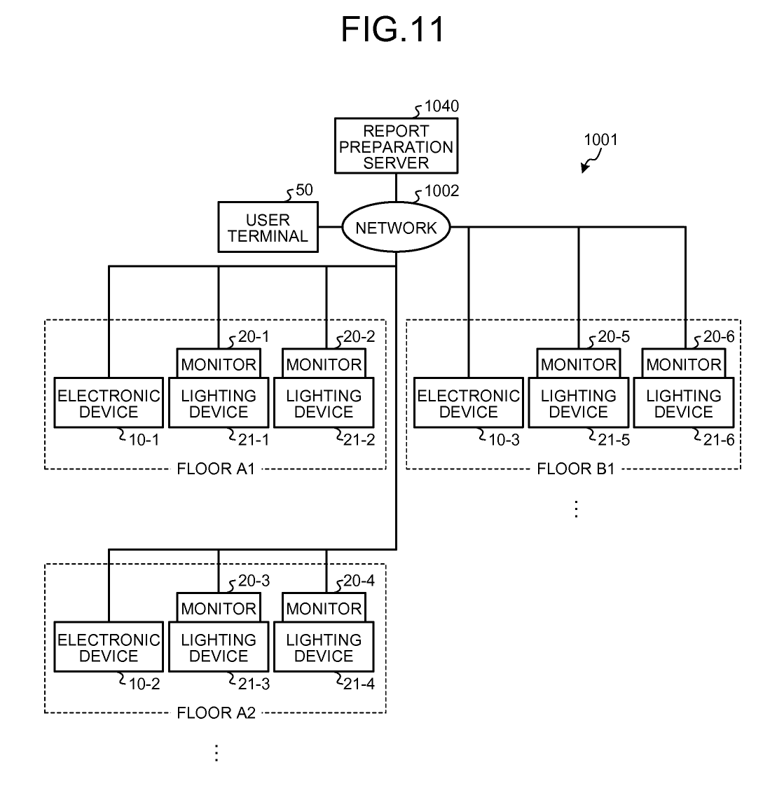

The above-described embodiment describes an example in which the report preparation server 40 and the collection servers 30-1, 30-2 form a cascade structure to manage the devices to be managed. Nonetheless, as illustrated in FIG. 11 that illustrates a device management system 1001, a single report preparation server 1040 may manage devices to be managed. The report preparation server 1040 only needs to have the functions the collection server 30 and the report preparation server 40 have, collecting the operating history information and preparing reports through a network 1002. The network 1002 may, for example, be the Internet or a LAN.

Eleventh Modification

The above-described embodiment describes an example in which the collection server 30 stores the unit electricity consumption table, the CO₂ emission coefficient, and the report information and the report preparation server 40 stores therein the report information. At least any of these types of information may be stored externally (e.g., a cloud environment).

Hardware Configuration

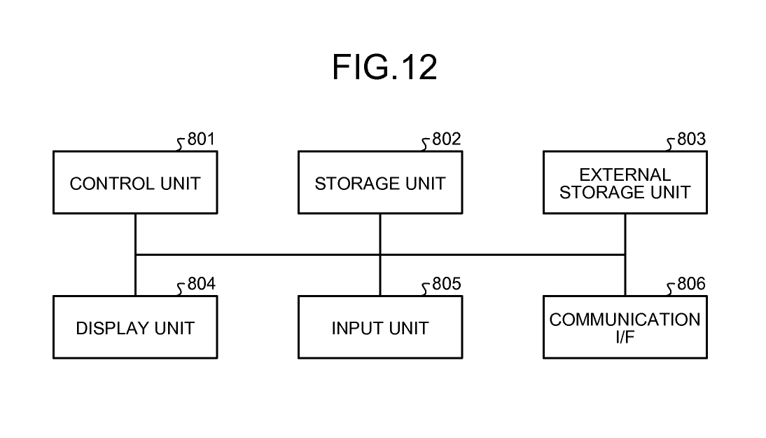

FIG. 12 is a block diagram illustrating an exemplary hardware configuration of the electronic device 10, the collection server 30, and the report preparation server 40 according to the embodiment and each of the modifications of the present invention. As illustrated in FIG. 12, the electronic device 10, the collection server 30, and the report preparation server 40 each include a control unit 801 such as a CPU, a storage unit 802 such as a ROM and a RAM, an external storage unit 803 such as an HDD and an SSD, a display unit 804 such as a display, an input unit 805 such as a mouse and a keyboard, and a communication I/F 806 such as a NIC, and can be achieved by a hardware configuration incorporating an ordinary computer. It is noted that the electronic device 10, if it is an MFP, further includes a scanning unit, such as a scanner, and a printing unit, such as a plotter.

The device management program to be executed by the collection server 30 and the report preparation server 40 according to the embodiment and each of the modifications of the present invention is provided by being recorded on a computer-readable recording medium, such as a CD-ROM, a CD-R, a memory card, a digital versatile disk (DVD), and a flexible disk (FD) in a file in an installable format or an executable format.

The device management program to be executed by the collection server 30 and the report preparation server 40 according to the embodiment and each of the modifications of the present invention may also be configured so as to be stored in a computer connected to a network such as the Internet and to be downloaded over the network. The device management program to be executed by the collection server 30 and the report preparation server 40 according to the embodiment and each of the modifications of the present invention may still be configured so as to be provided or distributed over a network such as the Internet. The device management program to be executed by the collection server 30 and the report preparation server 40 according to the embodiment and each of the modifications of the present invention may be provided by, for example, being incorporated in advance in a ROM.

The device management program to be executed by the collection server 30 and the report preparation server 40 according to the embodiment and each of the modifications of the present invention has a modular configuration for achieving each of the above-described elements on a computer. The control unit 801 as actual hardware loads the program from the external storage unit 803 onto the storage unit 802 and executes it. This achieves the abovementioned elements on the computer.

The present invention achieves an effect of enabling various types of devices connected over a network to be generally managed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A device management system that manages a first device and a second device via a network, the device management system comprising:
an acquiring section configured to acquire, from the first device, first operating history information relating to an operating history of the first device and acquire, from a monitor connected to the second device, second operating history information relating to an operating history of the second device, the second operating history information being of a type different from that of the first operating history information;
a first generating section configured to generate first management information based on the first operating history information; and
a second generating section configured to generate second management information of a type identical to that of the first management information based on the second operating history information.

2. The device management system according to claim 1, further comprising:
a report preparing section configured to prepare a report based on the first management information and the second management information.

3. The device management system according to claim 2, wherein the report preparing section prepares as the report a report that integrates the first management information with the second management information.

4. The device management system according to claim 2, wherein
the first generating section generates the first management information during a specified calculation period, and
the second generating section generates the second management information during the specified calculation period.

5. The device management system according to claim 2, wherein
the first device comprises a plurality of first devices and the second device comprises a plurality of second devices, and
the acquiring section acquires the first operating history information of, out of the first devices, a first device disposed at a specified site and the second operating history information of, out of the second devices, a second device disposed at the specified site.

6. The device management system according to claim 2, wherein
the first device is an electronic device,
the first operating history information indicates a model and an operation start date and time, and
the first management information indicates a carbon dioxide emission amount,
the device management system further comprises:
a unit electricity consumption table storage section configured to store therein a unit electricity consumption table that specifies model information indicating a model associated with unit electricity consumption information indicating electricity consumption per unit period; and
a carbon dioxide emission coefficient storage section configured to store therein a carbon dioxide emission coefficient,
the first generating section refers to the unit electricity consumption table to acquire the unit electricity consumption information associated with the model indicated by the first operating history information and calculates the carbon dioxide emission amount using the electricity consumption per unit period indicated by the acquired unit electricity consumption information, the operation start date and time indicated by the first operating history information, and the carbon dioxide emission coefficient.

7. The device management system according to claim 6, wherein
the second device is a lighting device,
the second operating history information indicates a rated electricity amount and a total lighting time,
the second management information indicates a carbon dioxide emission amount, and
the second generating section calculates the carbon dioxide emission amount using the rated electricity amount and the total lighting time indicated by the second operating history information and the carbon dioxide emission coefficient.

8. The device management system according to claim 2, wherein
the first device is an electronic device,
the first operating history information indicates a model and an operation start date and time, and
the first management information indicates electricity consumption,
the device management system further comprises:
a unit electricity consumption table storage section configured to store therein a unit electricity consumption table that specifies model information indicating a model associated with unit electricity consumption information indicating electricity consumption per unit period, and
the first generating section refers to the unit electricity consumption table to acquire the unit electricity consumption information associated with the model indicated by the first operating history information and calculates the electricity consumption using the electricity consumption per unit period indicated by the acquired unit electricity consumption information and the operation start date and time indicated by the first operating history information.

9. The device management system according to claim 8, wherein
the second device is a lighting device,
the second operating history information indicates a rated electricity amount and a total lighting time,
the second management information indicates electricity consumption, and
the second generating section calculates the electricity consumption using the rated electricity amount and the total lighting time indicated by the second operating history information.

10. The device management system according to claim 9, wherein
the first management information and the second management information further indicate electricity charges,
the device management system further comprises:
an electricity charge calculating coefficient storage section configured to store therein an electricity charge calculating coefficient,
the first generating section further calculates the electricity charges using the calculated electricity consumption and the electricity charge calculating coefficient, and
the second generating section further calculates the electricity charges using the calculated electricity consumption and the electricity charge calculating coefficient.

11. The device management system according to claim 7, wherein
the second operating history information further indicates an operation start date and time,
the second management information further indicates use frequency, and
the second generating section further calculates the use frequency using the total lighting time and the operation start date and time indicated by the second operating history information.

12. The device management system according to claim 9, wherein
the second operating history information further indicates an operation start date and time,
the second management information further indicates use frequency, and
the second generating section further calculates the use frequency using the total lighting time and the operation start date and time indicated by the second operating history information.

13. The device management system according to claim 7, wherein
the second operating history information further indicates a last lighting end date and time,
the second management information further indicates presence of a fault, and
the second generating section further determines the presence of a fault based on the last lighting end date and time indicated by the second operating history information.

14. The device management system according to claim 9, wherein
the second operating history information further indicates a last lighting end date and time,
the second management information further indicates presence of a fault, and
the second generating section further determines the presence of a fault based on the last lighting end date and time indicated by the second operating history information.

15. The device management system according to claim 7, wherein
the second operating history information further indicates models, and
the report preparing section prepares as the report a report that integrates the second management information for each of the models.

16. The device management system according to claim 9, wherein
the second operating history information further indicates models, and
the report preparing section prepares as the report a report that integrates the second management information for each of the models.

17. The device management system according to claim 15, wherein the report includes number of the models.

18. The device management system according to claim 16, wherein the report includes number of the models.

19. A device management apparatus that manages a first device and a second device via a network, the device management apparatus comprising:
an acquiring section configured to acquire, from the first device, first operating history information relating to an operating history of the first device and acquire, from a monitor connected to the second device, second operating history information relating to an operating history of the second device, the second operating history information being of a type different from that of the first operating history information;
a first generating section configured to generate first management information based on the first operating history information; and
a second generating section configured to generate second management information of a type identical to that of the first management information based on the second operating history information.

20. A device management method that manages a first device and a second device via a network, the device management method comprising:
acquiring, from the first device, first operating history information relating to an operating history of the first device and from a monitor connected to the second device, second operating history information relating to an operating history of the second device, the second operating history information being of a type different from that of the first operating history information;
generating first management information based on the first operating history information; and
generating second management information of a type identical to that of the first management information based on the second operating history information.
